(19) United States
(12) Patent Application Publication
(10) Pub. No.: US 2021/0256605 A1
(43) Pub. Date: Aug. 19, 2021

(54) METHOD AND DEVICE FOR FOREIGN EXCHANGE PURCHASE TRANSACTIONS

(71) Applicant: CHINA UNIONPAY CO., LTD., Shanghai (CN)

(72) Inventors: Tie LIU, Shanghai (CN); Cuiling QI, Shanghai (CN); Jianbin GAO, Shanghai (CN)

(21) Appl. No.: 17/246,655

(22) Filed: May 2, 2021

Related U.S. Application Data
(63) Continuation-in-part of application No. PCT/CN2019/112872, filed on Oct. 23, 2019.

(30) Foreign Application Priority Data
Nov. 6, 2018 (CN) 201811314406.1

(51) Int. Cl. G06Q 40/04; G06Q 20/38; G06Q 20/02

(52) U.S. Cl. CPC G06Q 40/04; G06Q 40/02; G06Q 20/023; G06Q 20/381

(57) ABSTRACT

Disclosed in the present invention are a method and a device for foreign exchange purchase transactions, said method comprising: predicting, according to historical transaction data, a predicted total foreign exchange purchase amount within a first set deadline; within an exchange rate stabilization period of the first set deadline, initiating a foreign exchange purchase transaction request according to the predicted total foreign exchange purchase amount, the foreign exchange purchase transaction request being used for purchasing, according to the exchange rate within the exchange rate stabilization period, foreign exchange of the predicted total foreign exchange purchase amount; after the first predetermined deadline expires, acquiring an actual total foreign exchange purchase amount within the first predetermined deadline; and performing transaction clearing according to the actual total foreign exchange purchase amount and the predicted total foreign exchange purchase amount.

### CROSS REFERENCE TO RELATED APPLICATIONS

This application is continuation-in-part of International Application No. PCT/CN2019/112872, filed on Oct. 23, 2019, which claims priority of Chinese Patent Application No. 201811314406.1, filed with the State Intellectual Property Office of P. R. China on Nov. 6, 2018 and entitled “METHOD AND DEVICE FOR FOREIGN EXCHANGE PURCHASE TRANSACTIONS”, the entire content of which is incorporated herein by reference.

### FIELD

The present disclosure relates to the field of e-commerce, in particular to a method and a device for foreign exchange purchase transactions.

### BACKGROUND

At present, a cross-border transaction settlement way mainly lies in that financial personnel perform payment and settlement for an oversea acquirer or merchant in a way of purchasing foreign exchange in various foreign exchange purchase banks after daily clearing data are cleared through a cross-border transaction settlement platform.

Since the existing cross-border transaction settlement way is relatively long in period to result in the possibility of relatively great difference of an exchange rate existing when a cardholder submits a transaction request and a bank exchange rate quote acquired artificially or by networking when the financial personnel perform payment and settlement, and furthermore, it is possible to cause the risk of high fund loss.

### SUMMARY

Provided in embodiments of the present application are a method and a device for foreign exchange purchase transactions, by which the exchange risk is reduced, and the exchange accuracy and efficiency are improved.

Provided in an embodiment of the present application is a method for foreign exchange purchase transactions, including:

predicting, according to historical transaction data, a predicted total foreign exchange purchase amount within a first set deadline;

within an exchange rate stabilization period of the first set deadline, initiating a foreign exchange purchase transaction request according to the predicted total foreign exchange purchase amount, the foreign exchange purchase transaction request being used for purchasing, according to an exchange rate within the exchange rate stabilization period, foreign exchange of the predicted total foreign exchange purchase amount;

after the first set deadline expires, acquiring an actual total foreign exchange purchase amount within the first set deadline; and

performing transaction clearing according to the actual total foreign exchange purchase amount and the predicted total foreign exchange purchase amount.

In a possible implementation, predicting, according to the historical transaction data, the predicted total foreign exchange purchase amount within the first set deadline, includes:

with the first set deadline as a set time period of a set date and each foreign exchange purchase period including K set dates:

acquiring, from the historical transaction data, each of N actual total foreign exchange purchase amounts within the first set deadline of a respective one of N foreign exchange purchase periods prior to the first set deadline;

acquiring, from the historical transaction data, each of M actual total foreign exchange purchase amounts within the set time period of a respective one of M set dates in the latest foreign exchange purchase period prior to the first set deadline; and

determining the predicted total foreign exchange purchase amount according to a first average value of the N actual total foreign exchange purchase amounts, a second average value of the M actual total foreign exchange purchase amounts, and K actual total foreign exchange purchase amounts among the N actual total foreign exchange purchase amounts, N, M and K being positive integers.

In a possible implementation, the predicted total foreign exchange purchase amount is expressed as:

Y=A×X1+B×X2+C×X3+D×X4

Y represents the predicted total foreign exchange purchase amount within the first set deadline.

X1 represents the first average value.

X2 represents the second average value of K actual total foreign exchange purchase amounts within the first set deadline in one tracing period prior to predicting time.

X3 and X4 represent two actual total foreign exchange purchase amounts within the first set deadline in the one tracing period; and A, B, C and D represent set parameters and have the sum equal to 1.

In a possible implementation, within the exchange rate stabilization period of the first set deadline, initiating the foreign exchange purchase transaction request according to the predicted total foreign exchange purchase amount, includes:

dividing the set deadline into a plurality of first foreign exchange purchase time periods according to exchange rate updating time;

dividing, according to the plurality of first foreign exchange purchase time periods, the predicted total foreign exchange purchase amount within the first set deadline, and determining a predicted foreign exchange purchase component in each of the first foreign exchange purchase time periods within the set deadline; and

within an exchange rate stabilization period in each of the first foreign exchange purchase time periods in the set deadline, initiating the foreign exchange purchase transaction request.

In a possible implementation, dividing, according to the plurality of first foreign exchange purchase time periods, the predicted total foreign exchange purchase amount within the first set deadline, and determining the predicted foreign exchange purchase component in each of the first foreign exchange purchase time periods within the first set deadline, includes:

determining, according to an actual total foreign exchange purchase amounts within the first set deadline in the one tracing period prior to the predicting time, first actual foreign exchange purchase components in the plurality of first foreign exchange purchase time periods within the first set deadline in the one tracing period;

acquiring a first actual total foreign exchange purchase amount within the first set deadline of an L^{th} foreign exchange purchase period prior to the first set deadline;

determining, according to the plurality of first foreign exchange purchase time periods, a plurality of first actual foreign exchange purchase components of the first actual total foreign exchange purchase amount in the plurality of first foreign exchange purchase time periods;

acquiring a second actual total foreign exchange purchase amount within a second set deadline, the second set deadline being same as the first set deadline in time duration and being located in a latest set deadline prior to the first set deadline;

determining, according to the plurality of first foreign exchange purchase time periods, a plurality of second actual foreign exchange purchase components of the second actual total foreign exchange purchase amount in the plurality of first foreign exchange purchase time periods;

acquiring a third actual total foreign exchange purchase amount within the second set deadline of the L^{th} foreign exchange purchase period;

determining, according to the plurality of first foreign exchange purchase time periods, a plurality of third actual foreign exchange purchase components of the third actual total foreign exchange purchase amount in the plurality of first foreign exchange purchase time periods;

determining a foreign exchange purchase ratio of each of the first foreign exchange purchase time periods to the plurality of foreign exchange purchase time periods according to the plurality of first actual foreign exchange purchase components in the plurality of first foreign exchange purchase time periods, the plurality of second actual foreign exchange purchase components in the plurality of first foreign exchange purchase time periods and the plurality of third actual foreign exchange purchase components in the plurality of first foreign exchange purchase time periods; and

determining a predicted foreign exchange purchase component in each of the first foreign exchange purchase time periods according to the foreign exchange purchase ratio of each of the first foreign exchange purchase time periods and the predicted total foreign exchange purchase amount.

In a possible implementation, a computing formula of the predicted foreign exchange purchase component is expressed as:

Ax=A×PCx

A represents the predicted total foreign exchange purchase amount within the first set deadline; and PCx represents a predicted relative foreign exchange purchase component and is used for representing a ratio of the predicted foreign exchange purchase component in an X^{th} first foreign exchange purchase time period within the first set deadline to the predicted total foreign exchange purchase amount within the first set deadline.

A computing formula of the predicted relative foreign exchange purchase component PCx is expressed as:

PCx=(Hx/Σₖ₌₁^{N}Hk)*(Px/Σₖ₌₁^{N}Pk)/(HPx/Σₖ₌₁^{N}HPk)

N≥x≥1; N represents the number of exchange rate updating time points; Px represents an actual foreign exchange purchase amount in the X^{th} first foreign exchange purchase time period within the second set deadline; Hx represents an actual foreign exchange purchase amount in the X^{th} first foreign exchange purchase time period within the first set deadline in one tracing period prior to the predicting time; and HPx represents an actual foreign exchange purchase amount in the X^{th} second foreign exchange purchase time period within the second set deadline in one tracing period prior to the predicting time.

Provided in an embodiment of the present application is a device for foreign exchange purchase transactions, including:

a prediction module, configured to predict, according to historical transaction data, a predicted total foreign exchange purchase amount within a first set deadline; and

a processing module, configured to, within an exchange rate stabilization period of the first set deadline, initiate a foreign exchange purchase transaction request according to the predicted total foreign exchange purchase amount, the foreign exchange purchase transaction request being used for purchasing, according to an exchange rate within the exchange rate stabilization period, foreign exchange of the predicted total foreign exchange purchase amount; after the first set deadline expires, acquire an actual total foreign exchange purchase amount within the first set deadline; and perform transaction clearing according to the actual total foreign exchange purchase amount and the predicted total foreign exchange purchase amount.

In a possible implementation, the prediction module is configured to: with the first set deadline as a set time period of a set date and each foreign exchange purchase period including K set dates;

acquire, from the historical transaction data, each of N actual total foreign exchange purchase amounts within the first set deadline of a respective one of N foreign exchange purchase periods prior to the first set deadline; acquire, from the historical transaction data, each of M actual total foreign exchange purchase amounts within the set time periods of a respective one of M set dates in the latest foreign exchange purchase period prior to the first set deadline; and determine the predicted total foreign exchange purchase amount according to a first average value of the N actual total foreign exchange purchase amounts, a second average value of the M actual total foreign exchange purchase amounts and K actual total foreign exchange purchase amounts among the N actual total foreign exchange purchase amounts, N, M and K being positive integers.

In a possible implementation, the predicted total foreign exchange purchase amount is expressed as:

Y=A×X1+B×X2+C×X3+D×X4

Y represents the predicted total foreign exchange purchase amount within the first set deadline.

X1 represents the first average value.

X2 represents the second average value of K actual total foreign exchange purchase amounts within the first set deadline in one tracing period prior to predicting time.

X3 and X4 represent two actual total foreign exchange purchase amounts within the first set deadline in the one tracing period; and A, B, C and D represent set parameters and have the sum equal to 1.

In a possible implementation, the processing module is configured to:

divide the set deadline into a plurality of first foreign exchange purchase time periods according to exchange rate updating time; divide, according to the plurality of first foreign exchange purchase time periods, the predicted total foreign exchange purchase amount within the first set deadline, and determine a predicted foreign exchange purchase component in each of the first foreign exchange purchase time periods within the set deadline; and within an exchange rate stabilization period in each of the first foreign exchange purchase time periods in the set deadline, initiate the foreign exchange purchase transaction request.

In a possible implementation, the processing module is configured to:

determine, according to an actual total foreign exchange purchase amount within the first set deadline in the one tracing period prior to the predicting time, first actual foreign exchange purchase components in the plurality of first foreign exchange purchase time periods within the first set deadline in the one tracing period; acquire a first actual total foreign exchange purchase amount within the first set deadline of an L^{th} foreign exchange purchase period prior to the first set deadline; determine, according to the plurality of first foreign exchange purchase time periods, a plurality of first actual foreign exchange purchase components of the first actual total foreign exchange purchase amount in the plurality of first foreign exchange purchase time periods; acquire a second actual total foreign exchange purchase amount within a second set deadline, here the second set deadline is same as the first set deadline in time duration and is located in a latest set deadline prior to the first set deadline; determine, according to the plurality of first foreign exchange purchase time periods, a plurality of second actual foreign exchange purchase components of the second actual total foreign exchange purchase amount in the plurality of first foreign exchange purchase time periods; acquire a third actual total foreign exchange purchase amount within the second set deadline of the L^{th} foreign exchange purchase period; determine, according to the plurality of first foreign exchange purchase time periods, a plurality of third actual foreign exchange purchase components of the third actual total foreign exchange purchase amount in the plurality of first foreign exchange purchase time periods; determine a foreign exchange purchase ratio of each of the first foreign exchange purchase time periods to the plurality of foreign exchange purchase time periods according to the plurality of first actual foreign exchange purchase components in the plurality of first foreign exchange purchase time periods, the plurality of second actual foreign exchange purchase components in the plurality of first foreign exchange purchase time periods and the plurality of third actual foreign exchange purchase components in the plurality of first foreign exchange purchase time periods; and determine a predicted foreign exchange purchase component in each of the first foreign exchange purchase time periods according to the foreign exchange purchase ratio of each of the first foreign exchange purchase time periods and the predicted total foreign exchange purchase amount.

In a possible implementation, a computing formula of the predicted foreign exchange purchase component is expressed as:

Ax=A×PCx

A represents the predicted total foreign exchange purchase amount within the first set deadline; and PCx represents a predicted relative foreign exchange purchase component and is used for representing a ratio of the predicted foreign exchange purchase component in an X^{th} first foreign exchange purchase time period within the first set deadline to the predicted total foreign exchange purchase amount within the first set deadline.

A computing formula of the predicted relative foreign exchange purchase component PCx is expressed as:

PCx=(Hx/Σₖ₌₁^{N}Hk)*(Px/Σₖ₌₁^{N}Pk)/(HPx/Σₖ₌₁^{N}HPk)

N≥x≥1; N represents the number of exchange rate updating time points; Px represents an actual foreign exchange purchase amount in the X^{th} first foreign exchange purchase time period within the second set deadline; Hx represents an actual foreign exchange purchase amount in the X^{th} first foreign exchange purchase time period within the first set deadline in one tracing period prior to the predicting time; and HPx represents an actual foreign exchange purchase amount in the X^{th} second foreign exchange purchase time period within the second set deadline in one tracing period prior to the predicting time.

Provided in an embodiment of the present application is a computing device, including at least one processing unit and at least one storage unit. The storage unit stores a computer program, and the processing unit is enabled to execute the steps of any one of the methods in the embodiments of the present application when the program is executed by the processing unit.

Provided in an embodiment of the present application is a computer readable storage medium. The computer readable storage medium stores a computer program executable for the computing device, and the computing device is enabled to execute the steps of any one of the methods in the embodiments of the present application when the program runs on the computing device.

In the embodiments of the present application, the total foreign exchange purchase amount within the first set deadline is predicted, before the first set deadline expires, the foreign exchange purchase transaction request is initiated in advance according to an exchange rate within the first set deadline, and the exchange rate is inquired according to a time period when the foreign exchange purchase transaction request is initiated, so that the exchange rate processing efficiency is increased, and the requirement of repeatedly purchasing foreign exchange in batches in a day for the exchange rate management efficiency is met. In addition, since the foreign exchange purchase transaction request is initiated in advance, the risk of high fund loss caused by exchange gain or loss appearing due to exchange rate update within the first set deadline when actual settlement is acquired after the first set deadline expires is avoided.

### BRIEF DESCRIPTION OF THE DRAWINGS

FIG. 1 is a flow diagram showing a method for foreign exchange purchase transactions in an embodiment of the present application;

FIG. 2 is a flow diagram showing a method for foreign exchange purchase transactions in an embodiment of the present application;

FIG. 3 is a schematic diagram showing a structure of a device for foreign exchange purchase transactions in an embodiment of the present application; and

FIG. 4 is a schematic diagram showing a structure of a device for foreign exchange purchase transactions in an embodiment of the present application.

### DETAILED DESCRIPTION OF THE EMBODIMENTS

A way for processing foreign exchange purchase in the prior art mainly lies in that a cross-border transaction settlement platform transmits a computed result of daily clearing data to a foreign exchange purchase management system, and a clearing agent bank computes the amount of required foreign currency funds after the system performs statistical summarization on trading positions. An exchange rate quote from a bank is acquired artificially or by networking. Foreign exchange purchase computation means that the required foreign currency funds are computed according to an acquired exchange rate to obtain required RMB. After preparing sufficient RMB funds, financial personnel transmit a foreign exchange purchase request to a foreign currency transaction platform to complete a foreign exchange purchase operation. If there is no high exchange rate fluctuation on two consecutive days, an exchange loss risk caused by such a foreign exchange purchase way is not high. However, in recent years, financial market events triggered by various international events such as Brexit take place frequently, thereby causing increasingly apparent exchange gain or loss; and the exchange rate has been changed five times a day at most, thereby resulting in exchange rate fluctuation greatly affecting the exchange gain or loss and particularly resulting in high fund loss when facing a high exchange rate fluctuation problem caused by significant international events.

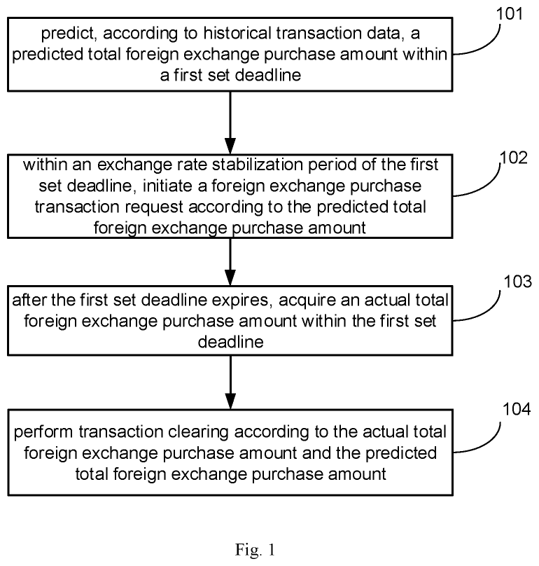

Based on the above-mentioned problems, provided in embodiments of the present application is a method for foreign exchange purchase transactions, as shown in FIG. 1, which includes the following steps.

Step 101: a predicted total foreign exchange purchase amount within a first set deadline is predicted according to historical transaction data.

Step 102: within an exchange rate stabilization period of the first set deadline, a foreign exchange purchase transaction request is initiated according to the predicted total foreign exchange purchase amount, and the foreign exchange purchase transaction request is used for purchasing, according to the exchange rate within the exchange rate stabilization period, foreign exchange of the predicted total foreign exchange purchase amount.

Step 103: after the first set deadline expires, an actual total foreign exchange purchase amount within the first set deadline is acquired.

Step 104: transaction clearing is performed according to the actual total foreign exchange purchase amount and the predicted total foreign exchange purchase amount.

It should be noted that the actual foreign exchange purchase amount within the first set deadline may be determined according to fund clearing data of a cross-border settlement platform after fund data is subjected to statistical summarization according to payment granularity. Specifically, the granularity of the first set deadline may be one day or hour and is not limited herein.

In embodiments of the present application, the total foreign exchange purchase amount within the first set deadline is predicted, within the exchange rate stabilization period of the first set deadline, the foreign exchange purchase transaction request is initiated in advance according to an exchange rate within the first set deadline, and the exchange rate is inquired according to a time period when the foreign exchange purchase transaction request is initiated, so that the exchange rate processing efficiency is increased, and the requirement of repeatedly purchasing foreign exchange in batches in a day for the exchange rate management efficiency is met. In addition, since the foreign exchange purchase transaction request is initiated in advance, the risk of high fund loss caused by exchange gain or loss appearing due to exchange rate update within the first set deadline when actual settlement is acquired after the first set deadline expires is avoided.

In some embodiments, a method for predicting a clearing amount within the first set deadline may be that the total foreign exchange purchase amount within the first set deadline is predicted according to a development track of historical batches. In a possible implementation, the step that a total foreign exchange purchase amount within a first set deadline is predicted according to historical transaction data includes the following operations.

Operation 1, N actual total foreign exchange purchase amounts within the first set deadline in N foreign exchange purchase periods prior to the current foreign exchange purchase period are acquired from the historical transaction data.

The first set deadline is taken as a set time period of a set date; and each foreign exchange purchase period includes K set dates.

Operation 2, M actual total foreign exchange purchase amounts within the set time period of M set dates in the latest foreign exchange purchase period prior to the current foreign exchange purchase period are acquired from the historical transaction data.

Operation 3, the predicted total foreign exchange purchase amount is determined according to a first average value of the N actual total foreign exchange purchase amounts, a second average value of the M actual total foreign exchange purchase amounts, and K actual total foreign exchange purchase amounts among the N actual total foreign exchange purchase amounts. N, M and K are positive integers.

In embodiments of the present application, the clearing amount may be predicted by adopting a trend extrapolation model, and in the prediction process, the total foreign exchange purchase amount within the first set deadline is speculated to be required by selecting historical data and planning an allocation weight of the historical data. With the first set deadline serving as the first set deadline on the day as an example, one tracing period is a week at least. The tracing period is the latest foreign exchange purchase period prior to the current foreign exchange purchase period. A prediction method may be described as follows.

The predicted total foreign exchange purchase amount is expressed as:

Y=A×X1+B×X2+C×X3+D×X4

Y represents the predicted total foreign exchange purchase amount within the first set deadline.

X1 represents the first average value.

X2 represents the second average value of K actual total foreign exchange purchase amounts within the first set deadline in one tracing period prior to predicting time.

X3 and X4 represent two actual total foreign exchange purchase amounts within the first set deadline in the one tracing period.

A, B, C and D represent set parameters and have the sum equal to 1.

For example, Y may be the predicted total foreign exchange purchase amount within the first set deadline (for example, the first set deadline is from 9:00 am to 12:00 at noon) on the day T; X1 may be an average value of “an actual total foreign exchange purchase amount within the first set deadline on the day T-7”, “an actual total foreign exchange purchase amount within the first set deadline on the day T-14” and “an actual total foreign exchange purchase amount within the first set deadline on the day T-21”; X2 may be a daily average value (of the actual total foreign exchange purchase amounts within the first set deadline from the day T-7 to the day T-1); X3 may be the actual total foreign exchange purchase amount within the first set deadline on the day T-7; X4 may be the actual total foreign exchange purchase amount within the first set deadline on the day T-1; and A, B, C and D represent proportional parameters and have the sum equal to 1. A, B, C and D may adopt global parameters to predict the total foreign exchange purchase amount Y within the first set deadline. Further, it is possible to respectively allocate the total foreign exchange purchase amount Y within the first set deadline for each currency according to currencies so as to improve the accuracy and flexibility of predicting the total foreign exchange purchase amount.

Of course, a way of determining the above-mentioned model is merely exemplarily described, and a tracing time period as well as specific time periods and number of all terms may be determined according to specific demands to improve the accuracy of predicting the total foreign exchange purchase amount.

In embodiments of the present application, fund clearing data of the cross-border transaction settlement platform is accepted, and the fund data is summarized according to the clearing agent bank and the dimensionality of a foreign currency to obtain the total foreign exchange purchase amount of the foreign currency.

During actual application, it is generally impossible to update the exchange rate very frequently in a day, with a quoted price of the bank of China as an example, the exchange rate is basically changed a little after being generally issued later than 10:30 am every day. Thus, the first set deadline may be determined according to updating time, for example, one day is set as one first set deadline, or one day is divided into two set deadlines, a time period earlier than 10:30 is used as the first set deadline, a time period later than 10:30 is used as a second set deadline, and thus, transaction clearing is performed in batches.

However, if the exchange rate is affected by some external factors, there will be relatively high fluctuation sometimes, and the exchange rate has been changed five times a day at most. It is possible that the first set deadline is not required to be further divided. In some embodiments of the present application, in order to further reduce exchange loss caused by the exchange rate, step 102 may be realized in the following way.

Operation 1, the first set deadline is divided into a plurality of first foreign exchange purchase time periods according to exchange rate updating time.

Operation 2, the predicted total foreign exchange purchase amount within the first set deadline is divided according to the plurality of first foreign exchange purchase time periods, and a predicted foreign exchange purchase component in each of the first foreign exchange purchase time periods within the first set deadline is determined.

Operation 3, within an exchange rate stabilization period in the first foreign exchange purchase time period(s) in the first set deadline, the foreign exchange purchase transaction request is initiated.

Specifically, the exchange rate stabilization period may be determined according to the exchange rate updating time. For example, in a possible implementation, it is possible that, when it reaches the moment of the foreign exchange purchase time period within the first set deadline, a bank exchange rate quote at the current moment is acquired, and a foreign exchange purchase transaction request is initiated according to the determined foreign exchange purchase component and the bank exchange rate quote at the current moment.

The total foreign exchange purchase amount within the first set deadline is predicted, a time period of the first set deadline is divided according to the exchange rate updating time, the total foreign exchange purchase amount within the first set deadline is divided into a plurality of foreign exchange purchase components, and the foreign exchange purchase transaction request for each foreign exchange purchase component is generated in each foreign exchange purchase time period, so that the risk of exchange fund loss caused by exchange rate fluctuation is avoided; and compared with foreign exchange purchase during actual settlement in the prior art, the risk of fund loss is greatly reduced.

It should be noted that the exchange rate in each foreign exchange purchase transaction request may be automatically enquired and compared by adopting technical means such as bank-corporate direct linkage and webpage crawlers to acquire a real-time optimal exchange rate in each foreign exchange purchase time period, so that the risk of fund loss is further reduced.

In an exemplary implementation, the division of the foreign exchange purchase amount means that the total foreign exchange purchase amount in a batch is divided according to a difference among exchange rates and a ratio of the different exchange rates. For the same batch, if the same exchange rate is used, the total foreign exchange purchase amount is not required to be divided. For example, if the exchange rate in the same batch has been updated once, the total foreign exchange purchase amount in a batch may be divided into two foreign exchange purchase time periods, the former foreign exchange purchase time period corresponds to a non-updated exchange rate, and the latter foreign exchange purchase time period corresponds to an updated exchange rate.

For example, normally, the exchange rate is changed relatively stably, and the time later than 10:30 am or about 5:00 pm every day is a main time point when the exchange rate is possible to change. In this way, the corresponding batches may be divided with 10:30 am and 5:00 pm as two division nodes.

In a possible implementation, the step that the total foreign exchange purchase amount within the first set deadline is divided according to the plurality of first foreign exchange purchase time periods, and a foreign exchange purchase component in each of the foreign exchange purchase time periods within the first set deadline is determined, includes the following operations.

Operation 1, first actual foreign exchange purchase components in the plurality of first foreign exchange purchase time periods within the first set deadline in the one tracing period are determined according to the actual total foreign exchange purchase amount within the first set deadline in the one tracing period prior to the predicting time.

Operation 2, a first actual total foreign exchange purchase amount within the first set deadline in an L^{th} foreign exchange purchase period prior to the predicting time is acquired. The predicting time refers to the first set deadline of the current foreign exchange purchase period.

Operation 3, a plurality of first actual foreign exchange purchase components of the first actual total foreign exchange purchase amount in the plurality of first foreign exchange purchase time periods are determined according to the plurality of first foreign exchange purchase time periods.

Operation 4, a second actual total foreign exchange purchase amount within a second set deadline is acquired. The second set deadline is same as the first set deadline in time duration and is located in a latest set deadline prior to the first set deadline.

Operation 5, a plurality of second actual foreign exchange purchase components of the second actual total foreign exchange purchase amount in the plurality of first foreign exchange purchase time periods are determined according to the plurality of first foreign exchange purchase time periods.

Operation 6, a third actual total foreign exchange purchase amount within the second set deadlines of the L^{th} foreign exchange purchase period is acquired.

Operation 7, a plurality of third actual foreign exchange purchase components of the third actual total foreign exchange purchase amount in the plurality of first foreign exchange purchase time periods are determined according to the plurality of first foreign exchange purchase time periods.

Operation 8, a foreign exchange purchase ratio of each of the first foreign exchange purchase time periods to the plurality of foreign exchange purchase time periods is determined according to the plurality of first actual foreign exchange purchase components in the plurality of first foreign exchange purchase time periods, the plurality of second actual foreign exchange purchase components in the plurality of first foreign exchange purchase time periods and the plurality of third actual foreign exchange purchase components in the plurality of first foreign exchange purchase time periods.

Operation 9, a predicted foreign exchange purchase component in each of the first foreign exchange purchase time periods is determined according to the foreign exchange purchase ratio of each of the first foreign exchange purchase time periods and the predicted total foreign exchange purchase amount.

It should be noted that the above-mentioned operations may be performed at the same time or sequentially performed, no order of time, which is not limited herein.

The predicted foreign exchange purchase components in the plurality of foreign exchange purchase time periods within the first set deadline are determined according to an actual clearing component in a second batch in at least one tracing time period and an actual clearing component within the first set deadline in the at least one tracing time period.

For example, one tracing time period is a week, and the first set deadline is a time slice on the day, the time slice means transaction occurrence time corresponding to the total foreign exchange purchase amount in a batch, that is, a transaction in one time slice is paid in a batch. A computing formula of the predicted foreign exchange purchase component is expressed as:

Ax=A×PCx

A represents the predicted total foreign exchange purchase amount within the first set deadline; and PCx represents a predicted relative foreign exchange purchase component and is used for representing a ratio of the predicted foreign exchange purchase component in an X^{th} first foreign exchange purchase time period within the first set deadline to the predicted total foreign exchange purchase amount within the first set deadline.

A computing formula of the predicted relative foreign exchange purchase component PCx is expressed as:

PCx=(Hx/Σₖ₌₁^{N}Hk)*(Px/Σₖ₌₁^{N}Pk)/(HPx/Σₖ₌₁^{N}HPk)

N≥x≥1; N represents the number of exchange rate updating time points; Px represents an actual foreign exchange purchase amount in the X^{th} first foreign exchange purchase time period within the second set deadline; Hx represents an actual foreign exchange purchase amount in the X^{th} first foreign exchange purchase time period within the first set deadline in one tracing period prior to the predicting time; and HPx represents an actual foreign exchange purchase amount in the X^{th} second foreign exchange purchase time period within the second set deadline in one tracing period prior to the predicting time.

For example, if TS is a starting time point of the first set deadline, TF is an expiring time point of the first set deadline. Hx may be the actual foreign exchange purchase amount in a time period TX−T(X+1) on the same day of last week, TX begins from TS, and the maximum value of T(X+1) is TF. HPx may be the actual foreign exchange purchase amount within a second set deadline with the time duration being same as that of TX−T(X+1) on the same day of last week, TX begins from TS, and the maximum value of T(X+1) is TF.

In a specific implementation process, the foreign exchange purchase transaction request may be initiated according to the predicted foreign exchange purchase component within an appointed time point.

In combination with the above-mentioned embodiments, if the total foreign exchange purchase amount is A and an exchange rate updating point is 1 node, there are two foreign exchange purchase time periods, and divided foreign exchange purchase components are respectively A1 and A2. For example, if the starting time point of the first set deadline is 10:00, the exchange rate updating time point is 11:00 and the expiring time point of the first set deadline is 12:00, the foreign exchange purchase transaction request may be initiated twice. That is, the foreign exchange purchase transaction request may be initiated once at 10:00 according to the component A1, and the foreign exchange purchase transaction request may be initiated once at 11:00 according to the component A2. The latest exchange rate quotes may be acquired for foreign exchange purchase performed twice in the corresponding foreign exchange purchase time periods.

The latest exchange rate quotes may be acquired in such a way that real-time exchange rate quotes are acquired from all banks or clearing agent banks by a bank-corporate linkage channel and in various ways such as a way of capturing an open quoted price on an open website, quotes of all the banks or the clearing agent banks are compared, and finally, the foreign exchange purchase transaction request is initiated to a selected foreign exchange purchase bank providing the optimal price. By using such a way for acquiring the exchange rate, the timeliness of the exchange rate is guaranteed, and the real-time foreign exchange purchase efficiency is increased.

Step 104 in which transaction clearing is performed according to the actual total foreign exchange purchase amount and the predicted total foreign exchange purchase amount includes:

after the first set deadline expires, the actual foreign exchange purchase amount within the first set deadline is acquired;

if it is determined that the actual foreign exchange purchase amount is smaller than or equal to the predicted total foreign exchange purchase amount of the foreign exchange purchase transaction request, an account of the foreign exchange purchase transaction request is cleared according to the actual foreign exchange purchase amount; and

if it is determined that the actual foreign exchange purchase amount is greater than the predicted total foreign exchange purchase amount of the foreign exchange purchase transaction request, after foreign exchange purchase is made up once according to the actual foreign exchange purchase amount, the account of the foreign exchange purchase transaction request is cleared.

Specifically, after the first set deadline expires or a new batch begins, the actual foreign exchange purchase amount within the first set deadline is acquired. If it is determined that the actual foreign exchange purchase amount within the first set deadline is smaller than or equal to the predicted total foreign exchange purchase amount, that is, there are sufficient foreign currencies required for payment, direct payment may be directly performed, and if there are remaining funds, the remaining funds may be used for payment within a new set deadline. If the actual foreign exchange purchase amount is greater than the predicted total foreign exchange purchase amount of the foreign exchange purchase transaction request, foreign exchange purchase may be made up once for a foreign currency gap, and then, payment is performed after foreign currency funds are replenished to be sufficient.

In embodiments of the present application, the fund clearing data of the cross-border transaction settlement platform is accepted, and the fund data is summarized according to the clearing agent bank and the dimensionality of a foreign currency to obtain the total foreign exchange purchase amount of the foreign currency. In combination with that the total foreign exchange purchase amount is predicted, the total foreign exchange purchase amount is divided into the plurality of foreign exchange purchase components according to the updated exchange rate, and the foreign exchange purchase requests are initiated in the plurality of foreign exchange purchase time periods, foreign exchange may be purchased from the foreign exchange purchase bank selected in real time according to each of the foreign exchange purchase requests, and the purchased foreign exchange funds are finally paid for an oversea agency or merchant according to the actual foreign exchange purchase amount after the first set deadline expires, so that the foreign exchange purchase efficiency is increased, and fund risks brought by exchange gain or loss are reduced.

By using the above-mentioned method, parameters in a prediction model may also be regulated to improve the accuracy of the model predicting the total foreign exchange purchase amount.

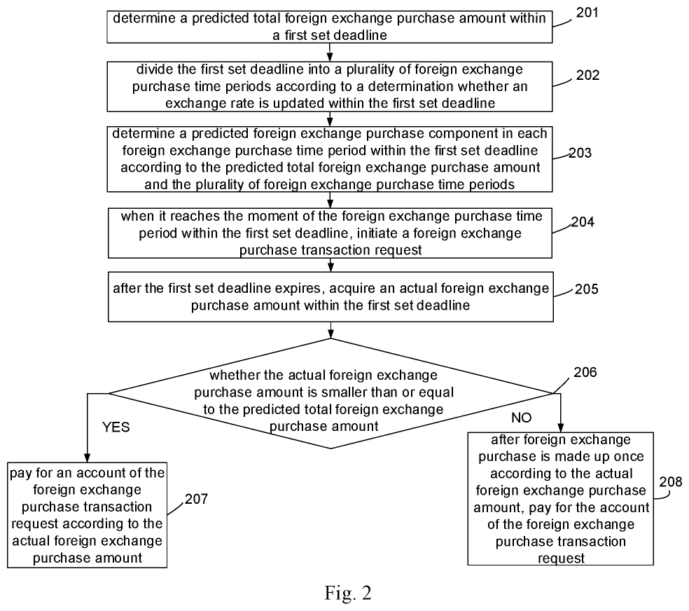

As shown in FIG. 2, the working principle of each step will be described in detail below.

Step 201: a predicted total foreign exchange purchase amount within a first set deadline is determined.

Step 202: the first set deadline is divided into a plurality of foreign exchange purchase time periods according to a determination whether an exchange rate is updated within the first set deadline.

Step 203: a predicted foreign exchange purchase component in each foreign exchange purchase time period within the first set deadline is determined according to the predicted total foreign exchange purchase amount and the plurality of foreign exchange purchase time periods.

Step 204: when it reaches the moment of the foreign exchange purchase time period within the first set deadline, a bank exchange rate quote at the current time is acquired, and a foreign exchange purchase transaction request is initiated according to the foreign exchange purchase component and the bank exchange rate quote at the current moment.

Step 205: after the first set deadline expires, an actual foreign exchange purchase amount within the first set deadline is acquired.

Step 206: if it is determined that the actual foreign exchange purchase amount is smaller than or equal to the predicted total foreign exchange purchase amount of the foreign exchange purchase transaction request, step 207 is performed; or else, step 208 is performed.

Step 207: an account of the foreign exchange purchase transaction request is paid according to the actual foreign exchange purchase amount.

Step 208: after foreign exchange purchase is made up once according to the actual foreign exchange purchase amount, the account of the foreign exchange purchase transaction request is paid.

A flow process of a foreign exchange purchase transaction will be exemplarily described with a specific example as below. For example, a fund settlement was required at 9:00 am to 12:00 at noon on Sep. 11, 2018, and it was determined that the exchange rate was updated once at 11 o'clock. Before 9:00, an overall transaction of US dollars at 9:00 to 12:00 may be predicted according to a transaction amount prediction algorithm:

Y=A×B1+B×X2+C×X3+D×X4

The predicted total foreign exchange purchase amount of the US dollars was 0.12 billion by computation (it was assumed that values of A, B, C and D were all 0.25, X1=0.1 billion, X2=0.11 billion, X3=0.13 billion, and X4=0.14 billion).

After the total foreign exchange purchase amount was predicted, the total foreign exchange purchase amount within the first set deadline was divided with 11:00 as a time node, two foreign exchange purchase time periods were determined, the exchange rate was only updated once in the first set deadline, and the total foreign exchange purchase amount was required to be divided into two time periods, that is, N=2. A division ratio was computed according to a division algorithm. For a second batch, that is, the total foreign exchange purchase amount at a time period from 6:00 to 9:00, a transaction amount ratio in the two time periods with 8:00 as a division point was 2:1. For the total foreign exchange purchase amount within the first set deadline at the same time of last week, that is, the total foreign exchange purchase amount in a time period from 9:00 to 12:00 on September 4^{th}, the transaction amount ratio in the two time periods with 11:00 as a division point was 2:1. For a second batch at the same time of last week, that is, the total foreign exchange purchase amount in a time period from 6:00 to 9:00 on September 4th, a transaction amount ratio in the two time periods with 8:00 as a division point was 2:1.

Computed according to PCx=(Hx/Σₖ₌₁^{N}Hk)*Px/(HPx/Σₖ₌₁^{N}HPk), a time slice from 9:00 to 12:00 on September 11^{th} should be divided into two time periods, and the ratios were respectively PC1=2/3, and PC2=1/3.

Two foreign exchange purchase components were computed to be respectively achieved as A1=1.2×2/3=0.08 billion, and A2=1.2×1/3=0.04 billion.

Finally, foreign exchange purchase personnel were required to purchase 0.08 billion US dollars at 9 o'clock and 0.04 billion US dollars at 11 o'clock.

If it was determined that the actual foreign exchange purchase amount at 12:00 was 0.12 billion US dollars, compared with a way of purchasing 0.12 billion US dollars at 12:00 according to an exchange rate at 12:00 in the prior art, the solution in the embodiments of the present application lies in that the exchange rate difference of 0.08 billion US dollars purchased at 9 o'clock is reduced, and the risk of fund loss in an exchange transaction is reduced.

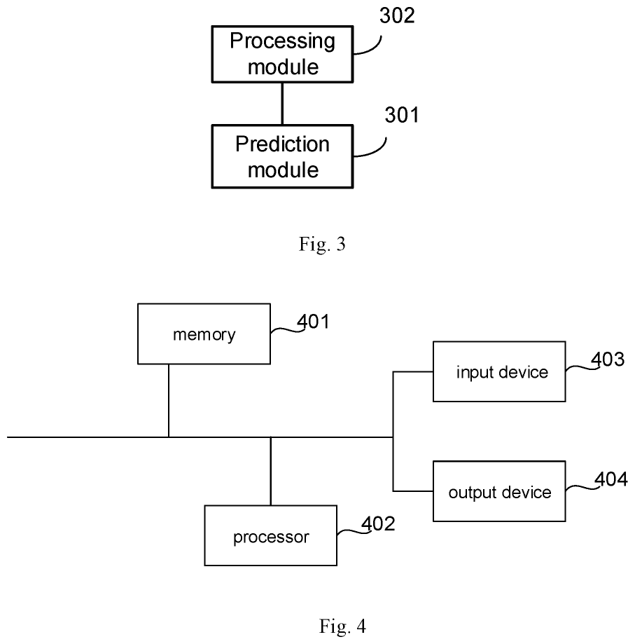

Based on the same technical concept, further provided in embodiments of the present application is a device for foreign exchange purchase transactions, as shown in FIG. 3, including:

a prediction module 301, configured to predict, according to historical transaction data, a predicted total foreign exchange purchase amount within a first set deadline; and

a processing module 302, configured to, within an exchange rate stabilization period of the first set deadline, initiate a foreign exchange purchase transaction request according to the predicted total foreign exchange purchase amount, the foreign exchange purchase transaction request being used for purchasing, according to the exchange rate within the exchange rate stabilization period, foreign exchange of the predicted total foreign exchange purchase amount; after the first set deadline expires, acquire an actual total foreign exchange purchase amount within the first set deadline; and perform transaction clearing according to the actual total foreign exchange purchase amount and the predicted total foreign exchange purchase amount.

In a possible implementation, the prediction module 301 is configured to: with the first set deadline as a set time period of a set date and each foreign exchange purchase period including K set dates;

acquire, from the historical transaction data, each of N actual total foreign exchange purchase amounts within the first set deadline in a respective one of N foreign exchange purchase periods prior to the first set deadline; acquire, from the historical transaction data, each of M actual total foreign exchange purchase amounts within the set time period, within the first set deadline, of M set dates in the latest foreign exchange purchase period prior to the first set deadline; and determine the predicted total foreign exchange purchase amount according to a first average value of the N actual total foreign exchange purchase amounts, a second average value of the M actual total foreign exchange purchase amounts and K actual total foreign exchange purchase amounts in the N actual total foreign exchange purchase amounts, N, M and K being positive integers.

In a possible implementation, the predicted total foreign exchange purchase amount is expressed as:

Y=A×X1+B×X2+C×X3+D×X4

Y represents the predicted total foreign exchange purchase amount within the first set deadline.

X1 represents the first average value.

X2 represents the second average value of K actual total foreign exchange purchase amounts within the first set deadline in one tracing period prior to predicting time.

X3 and X4 represent two actual total foreign exchange purchase amounts within the first set deadline in the one tracing period; and A, B, C and D represent set parameters and have the sum equal to 1.

In a possible implementation, the processing module 302 is configured to:

divide the set deadline into a plurality of first foreign exchange purchase time periods according to exchange rate updating time; divide, according to the plurality of first foreign exchange purchase time periods, the predicted total foreign exchange purchase amount within the first set deadline, and determine a predicted foreign exchange purchase component in each of the first foreign exchange purchase time periods within the set deadline; and within an exchange rate stabilization period in the first foreign exchange purchase time period(s) in the set deadline, initiate the foreign exchange purchase transaction request.

In a possible implementation, the processing module is configured to:

determine, according to the actual total foreign exchange purchase amounts within the first set deadline in the one tracing period prior to the predicting time, first actual foreign exchange purchase components in the plurality of first foreign exchange purchase periods within the first set deadline in the one tracing period; acquire a first actual total foreign exchange purchase amount within the first set deadline of an L^{th} foreign exchange purchase period prior to the first set deadline; determine, according to the plurality of first foreign exchange purchase time periods, a plurality of first actual foreign exchange purchase components of the first actual total foreign exchange purchase amount in the plurality of first foreign exchange purchase time periods; acquire a second actual total foreign exchange purchase amount within a second set deadline, wherein the second set deadline is same as the first set deadline in time duration and is located in a latest set deadline prior to the first set deadline; determine, according to the plurality of first foreign exchange purchase time periods, a plurality of second actual foreign exchange purchase components of the second actual total foreign exchange purchase amount in the plurality of first foreign exchange purchase time periods; acquire a third actual total foreign exchange purchase amount within the second set deadline of the L^{th} foreign exchange purchase period; determine, according to the plurality of first foreign exchange purchase time periods, a plurality of third actual foreign exchange purchase components of the third actual total foreign exchange purchase amount in the plurality of first foreign exchange purchase time periods; determine a ratio of each of the first foreign exchange purchase time periods to the plurality of foreign exchange purchase time periods according to the plurality of first actual foreign exchange purchase components in the plurality of first foreign exchange purchase time periods, the plurality of second actual foreign exchange purchase components in the plurality of first foreign exchange purchase time periods and the plurality of third actual foreign exchange purchase components in the plurality of first foreign exchange purchase time periods; and determine a predicted foreign exchange purchase component in each of the first foreign exchange purchase time periods according to the ratio of each of the first foreign exchange purchase time periods and the predicted total foreign exchange purchase amount.

In a possible implementation, a computing formula of the predicted foreign exchange purchase component is expressed as:

Ax=A×PCx

A represents the predicted total foreign exchange purchase amount within the first set deadline; and PCx represents a predicted relative foreign exchange purchase component and is used for representing a ratio of the predicted foreign exchange purchase component in an X^{th} first foreign exchange purchase time period within the first set deadline to the predicted total foreign exchange purchase amount within the first set deadline.

A computing formula of the predicted relative foreign exchange purchase component PCx is expressed as:

PCx=(Hx/Σₖ₌₁^{N}Hk)*(Px/Σₖ₌₁^{N}Pk)/(HPx/Σₖ₌₁^{N}HPk)

N≥x≥1; N represents the number of exchange rate updating time points; Px represents an actual foreign exchange purchase amount in the X^{th} first foreign exchange purchase time period within the second set deadline; Hx represents an actual foreign exchange purchase amount in the X^{th} first foreign exchange purchase time period within the first set deadline in one tracing period prior to the predicting time; and HPx represents an actual foreign exchange purchase amount in the X^{th} second foreign exchange purchase time period within the second set deadline in one tracing period prior to the predicting time.

Provided in an embodiment of the present application is a computing device, including at least one processing unit and at least one storage unit, the storage unit stores a computer program, and the processing unit is enabled to execute the steps of the method for foreign exchange purchase transactions when the program is executed by the processing unit. As shown in FIG. 4 which is a schematic diagram showing a hardware structure of the computing device in the embodiment of the present application, the computing device may be specifically a desk computer, a portable computer, a smart phone, a tablet personal computer and the like. Specifically, the computing device may include a memory 401, a processor 402 and a computer program stored on the memory, and the steps of any one of the methods for foreign exchange purchase transactions in the above-mentioned embodiments are implemented when the processor 402 executes the program. The memory 401 may include a read-only memory (ROM) and a random access memory (RAM) and provide a program instruction and data stored in the memory 401 to the processor 402.

Further, the computing device in the embodiment of the present application may further include an input device 403, an output device 404 and the like. The input device 403 may include a keyboard, a mouse, a touch screen and the like; and the output device 404 may include a display device such as an LCD (Liquid Crystal Display), a CRT (Cathode Ray Tube) and a touch screen. The memory 401, the processor 402, the input device 403 and the output device 404 may be connected by a bus or in other ways, for example, connected by the bus in FIG. 4. The processor 402 calls the program instruction stored by the memory 401 and executes the method for foreign exchange purchase transactions in the above-mentioned embodiment according to the acquired program instruction.

Further provided in an embodiment of the present application is a computer readable storage medium. The computer readable storage medium stores a computer program executable for the computing device, and the computing device is enabled to execute steps of a method for breast molybdenum target image recognition when the program runs on the computing device.

The present application is described by referring to flow diagrams and/or block diagrams of the method, device (system) and computer program product according to the embodiments of the present application. It should be understood that each flow and/or block in the flow diagrams and/or block diagrams as well as a combination of flows and/or blocks in the flow diagrams and/or block diagrams may be achieved by computer program instructions. These computer program instructions may be provided to a general-purpose computer, a special-purpose computer, an embedded processor or processors of other programmable data processing devices to generate a machine, so that a device for achieving specified functions in one or more flows in the flow programs and/or one or more blocks in the block diagrams is generated through the instructions executed by the computer or the processors of other programmable data processing devices.

These computer program instructions may also be stored in a computer readable memory capable of guiding the computer or other programmable data processing devices to work in a specific way, so that the instructions stored in the computer readable memory generate a product including an instruction device, and the instruction device achieves the functions specified in the one or more flows in the flow diagrams and/or one or more blocks in the block diagrams.

These computer program instructions may also be loaded in the computer or other programmable data processing devices, so that a series of operation steps are performed on the computer or other programmable data processing devices to generate processing realized by the computer, and furthermore, the instructions executed on the computer or other programmable data processing devices provide steps for achieving the specified functions in the one or more flows in the flow diagrams and/or one or more blocks in the block diagrams.

Although the preferred embodiments of the present application have been described, those skilled in the art can make additional changes and modifications on these embodiments once they acquire the basic creative concept. Therefore, attached claims are intended to be explained to include the preferred embodiments and all the changes and modifications that fall within the scope of the present application.

Obviously, those skilled in the art can make various changes and modifications to the present application without departing from the spirit and scope of the present application. Thus, the present application is also intended to encompass these changes and modifications if such changes and modifications of the present application fall within the scope of the claims of the present application and equivalents thereof.

What is claimed is:

1. A method for foreign exchange purchase transactions, comprising:
predicting, according to historical transaction data, a predicted total foreign exchange purchase amount within a first set deadline of a current foreign exchange purchase period;
within an exchange rate stabilization period of the first set deadline of the current foreign exchange purchase period, initiating a foreign exchange purchase transaction request according to the predicted total foreign exchange purchase amount, the foreign exchange purchase transaction request being used for purchasing, according to an exchange rate within the exchange rate stabilization period, foreign exchange of the predicted total foreign exchange purchase amount;
after the first set deadline of the current foreign exchange purchase period expires, acquiring an actual total foreign exchange purchase amount within the first set deadline of the current foreign exchange purchase period; and
performing transaction clearing according to the actual total foreign exchange purchase amount and the predicted total foreign exchange purchase amount.

2. The method according to claim 1, wherein said predicting, according to the historical transaction data, the predicted total foreign exchange purchase amount within the first set deadline of the current foreign exchange purchase period, comprises:
with the first set deadline as a set time period of a set date and each foreign exchange purchase period comprising K set dates:
acquiring, from the historical transaction data, each of N actual total foreign exchange purchase amounts within the first set deadline of a respective one of N foreign exchange purchase periods prior to the current foreign exchange purchase period;
acquiring, from the historical transaction data, each of M actual total foreign exchange purchase amounts within the set time period of a respective one of M set dates in the latest foreign exchange purchase period prior to the current foreign exchange purchase period; and
determining the predicted total foreign exchange purchase amount according to a first average value of the N actual total foreign exchange purchase amounts, a second average value of the M actual total foreign exchange purchase amounts, and K actual total foreign exchange purchase amounts among the N actual total foreign exchange purchase amounts, wherein N, M and K are positive integers, and M is equal to or less than K.

3. The method according to claim 2, wherein the predicted total foreign exchange purchase amount is expressed as:
Y=A×X1+B×X2+C×X3+D×X4
wherein Y represents the predicted total foreign exchange purchase amount within the first set deadline of the current foreign exchange purchase period;
X1 represents the first average value;
X2 represents the second average value of K actual total foreign exchange purchase amounts within the first set deadline of the latest foreign exchange purchase period; and
X3 and X4 represent two actual total foreign exchange purchase amounts within the first set deadline of the latest foreign exchange purchase period; and A, B, C and D represent set parameters and have the sum equal to 1.

4. The method according to claim 1, wherein said within the exchange rate stabilization period of the first set deadline of the current foreign exchange purchase period, initiating the foreign exchange purchase transaction request according to the predicted total foreign exchange purchase amount, comprises:
dividing the first set deadline of the current foreign exchange purchase period into a plurality of first foreign exchange purchase time periods according to exchange rate updating time;
dividing, according to the plurality of first foreign exchange purchase time periods, the predicted total foreign exchange purchase amount within the first set deadline of the current foreign exchange purchase period, and determining a predicted foreign exchange purchase component in each of the first foreign exchange purchase time periods within the first set deadline of the current foreign exchange purchase period; and
within an exchange rate stabilization period in each of the first foreign exchange purchase time periods in the first set deadline of the current foreign exchange purchase period, initiating the foreign exchange purchase transaction request.

5. The method according to claim 4, wherein said dividing, according to the plurality of first foreign exchange purchase time periods, the predicted total foreign exchange purchase amount within the first set deadline of the current foreign exchange purchase period, and determining the predicted foreign exchange purchase component in each of the first foreign exchange purchase time periods within the first set deadline of the current foreign exchange purchase period, comprises:
determining, according to an actual total foreign exchange purchase amount within the first set deadline of the latest foreign exchange purchase period, first actual foreign exchange purchase components in the plurality of first foreign exchange purchase periods within the first set deadline of the latest foreign exchange purchase period;
acquiring a first actual total foreign exchange purchase amount within the first set deadline of an L^{th} foreign exchange purchase period prior to the current foreign exchange purchase period;
determining, according to the plurality of first foreign exchange purchase time periods, a plurality of first actual foreign exchange purchase components of the first actual total foreign exchange purchase amount in the plurality of first foreign exchange purchase time periods;
acquiring a second actual total foreign exchange purchase amount within a second set deadline of the current foreign exchange purchase period, wherein the second set deadline is same as the first set deadline in time duration and is located in a latest set deadline prior to the first set deadline;
determining, according to the plurality of first foreign exchange purchase time periods, a plurality of second actual foreign exchange purchase components of the second actual total foreign exchange purchase amount in the plurality of first foreign exchange purchase time periods;
acquiring a third actual total foreign exchange purchase amount within the second set deadline of the L^{th} foreign exchange purchase period;
determining, according to the plurality of first foreign exchange purchase time periods, a plurality of third actual foreign exchange purchase components of the third actual total foreign exchange purchase amount in the plurality of first foreign exchange purchase time periods;
determining a foreign exchange purchase ratio of each of the first foreign exchange purchase time periods to the plurality of foreign exchange purchase time periods according to the plurality of first actual foreign exchange purchase components in the plurality of first foreign exchange purchase time periods, the plurality of second actual foreign exchange purchase components in the plurality of first foreign exchange purchase time periods and the plurality of third actual foreign exchange purchase components in the plurality of first foreign exchange purchase time periods; and
determining a predicted foreign exchange purchase component in each of the first foreign exchange purchase time periods according to the foreign exchange purchase ratio of each of the first foreign exchange purchase time periods and the predicted total foreign exchange purchase amount.

6. The method according to claim 5, wherein a computing formula of the predicted foreign exchange purchase component is expressed as:
Ax=A×PCx;
wherein A represents the predicted total foreign exchange purchase amount within the first set deadline of the current foreign exchange purchase period; and PCx represents a predicted relative foreign exchange purchase component and is used for representing a ratio of the predicted foreign exchange purchase component in an X^{th} first foreign exchange purchase time period within the first set deadline of the current foreign exchange purchase period to the predicted total foreign exchange purchase amount within the first set deadline of the current foreign exchange purchase period;
a computing formula of the predicted relative foreign exchange purchase component PCx is expressed as:
PCx=(Hx/Σₖ₌₁^{N}Hk)*(Px/Σₖ₌₁^{N}Pk)/(HPx/Σₖ₌₁^{N}HPk)
wherein N≥x≥1; represents the number of the first foreign exchange purchase time periods within the first set deadline of the current foreign exchange purchase period; Px represents an actual foreign exchange purchase amount in the X^{th} first foreign exchange purchase time period within the second set deadline of the current foreign exchange purchase period; Hx represents an actual foreign exchange purchase amount in the X^{th} first foreign exchange purchase time period within the first set deadline of the latest foreign exchange purchase period; and HPx represents an actual foreign exchange purchase amount in the X^{th} second foreign exchange purchase time period within the second set deadline of the latest foreign exchange purchase period.

7. A device for foreign exchange purchase transactions, comprising at least one processor and at least one memory, wherein the at least one memory stores a computer program, and the at least one processor, by executing the computer program, is configured to:
predict, according to historical transaction data, a predicted total foreign exchange purchase amount within a first set deadline of a current foreign exchange purchase period, and
within an exchange rate stabilization period of the first set deadline of the current foreign exchange purchase period, initiate a foreign exchange purchase transaction request according to the predicted total foreign exchange purchase amount, the foreign exchange purchase transaction request being used for purchasing, according to an exchange rate within the exchange rate stabilization period, foreign exchange of the predicted total foreign exchange purchase amount; after the first set deadline of the current foreign exchange purchase period expires, acquire an actual total foreign exchange purchase amount within the first set deadline of the current foreign exchange purchase period; and perform transaction clearing according to the actual total foreign exchange purchase amount and the predicted total foreign exchange purchase amount.

8. The device according to claim 7, wherein the processor is further configured to: with the first set deadline as a set time period of a set date and each foreign exchange purchase period comprising K set dates;
acquire, from the historical transaction data, each of N actual total foreign exchange purchase amounts within the first set deadline of a respective one of N foreign exchange purchase periods prior to the current foreign exchange purchase period; acquire, from the historical transaction data, each of M actual total foreign exchange purchase amounts within the set time period of a respective one of M set dates in the latest foreign exchange purchase period prior to the current foreign exchange purchase period; and determine the predicted total foreign exchange purchase amount according to a first average value of the N actual total foreign exchange purchase amounts, a second average value of the M actual total foreign exchange purchase amounts and K actual total foreign exchange purchase amounts among the N actual total foreign exchange purchase amounts, wherein N, M and K are positive integers, and M is equal to or less than K.

9. The device according to claim 8, wherein the predicted total foreign exchange purchase amount is expressed as:
Y=A×X1+B×X2+C×X3+D×X4
wherein Y represents the predicted total foreign exchange purchase amount within the first set deadline of the current foreign exchange purchase period;
X1 represents the first average value;
X2 represents the second average value of K actual total foreign exchange purchase amounts within the first set deadline of the latest foreign exchange purchase period; and
X3 and X4 represent two actual total foreign exchange purchase amounts within the first set deadline of the latest foreign exchange purchase period; and A, B, C and D represent set parameters and have the sum equal to 1.

10. The device according to claim 7, wherein the processor is further configured to:
divide the first set deadline of the current foreign exchange purchase period into a plurality of first foreign exchange purchase time periods according to exchange rate updating time; divide, according to the plurality of first foreign exchange purchase time periods, the predicted total foreign exchange purchase amount within the first set deadline of the current foreign exchange purchase period, and determine a predicted foreign exchange purchase component in each of the first foreign exchange purchase time periods within the first set deadline of the current foreign exchange purchase period; and within an exchange rate stabilization period in each of the first foreign exchange purchase time periods in the first set deadline of the current foreign exchange purchase period, initiate the foreign exchange purchase transaction request.

11. The device according to claim 10, wherein the processor is further configured to:
determine, according to an actual total foreign exchange purchase amount within the first set deadline of the latest foreign exchange purchase period, first actual foreign exchange purchase components in the plurality of first foreign exchange purchase periods within the first set deadline of the latest foreign exchange purchase period; acquire a first actual total foreign exchange purchase amount within the first set deadline of an L^{th} foreign exchange purchase period prior to the current foreign exchange purchase period; determine, according to the plurality of first foreign exchange purchase time periods, a plurality of first actual foreign exchange purchase components of the first actual total foreign exchange purchase amount in the plurality of first foreign exchange purchase time periods; acquire a second actual total foreign exchange purchase amount within a second set deadline of the current foreign exchange purchase period, wherein the second set deadline is same as the first set deadline in time duration and is located in a latest set deadline prior to the first set deadline; determine, according to the plurality of first foreign exchange purchase time periods, a plurality of second actual foreign exchange purchase components of the second actual total foreign exchange purchase amount in the plurality of first foreign exchange purchase time periods; acquire a third actual total foreign exchange purchase amount within the second set deadline of the L^{th} foreign exchange purchase period; determine, according to the plurality of first foreign exchange purchase time periods, a plurality of third actual foreign exchange purchase components of the third actual total foreign exchange purchase amount in the plurality of first foreign exchange purchase time periods; determine a foreign exchange purchase ratio of each of the first foreign exchange purchase time periods to the plurality of foreign exchange purchase time periods according to the plurality of first actual foreign exchange purchase components in the plurality of first foreign exchange purchase time periods, the plurality of second actual foreign exchange purchase components in the plurality of first foreign exchange purchase time periods and the plurality of third actual foreign exchange purchase components in the plurality of first foreign exchange purchase time periods; and determine a predicted foreign exchange purchase component in each of the first foreign exchange purchase time periods according to the foreign exchange purchase ratio of each of the first foreign exchange purchase time periods and the predicted total foreign exchange purchase amount.

12. The device according to claim 11, wherein a computing formula of the predicted foreign exchange purchase component is expressed as:
Ax=A×PCx;
wherein A represents the predicted total foreign exchange purchase amount within the first set deadline of the current foreign exchange purchase period; and PCx represents a predicted relative foreign exchange purchase component and is used for representing a ratio of the predicted foreign exchange purchase component in an X^{th} first foreign exchange purchase time period within the first set deadline of the current foreign exchange purchase period to the predicted total foreign exchange purchase amount within the first set deadline of the current foreign exchange purchase period;
a computing formula of the predicted relative foreign exchange purchase component PCx is expressed as:
PCx=(Hx/Σₖ₌₁^{N}Hk)*(Px/Σₖ₌₁^{N}Pk)/(HPx/Σₖ₌₁^{N}HPk)
wherein N≥x≥1; N represents the number of the first foreign exchange purchase time periods within the first set deadline of the current foreign exchange purchase period; Px represents an actual foreign exchange purchase amount in the X^{th} first foreign exchange purchase time period within the second set deadline of the current foreign exchange purchase period; Hx represents an actual foreign exchange purchase amount in the X^{th} first foreign exchange purchase time period within the first set deadline of the latest foreign exchange purchase period; and HPx represents an actual foreign exchange purchase amount in the X^{th} second foreign exchange purchase time period within the second set deadline of the latest foreign exchange purchase period.

13. A non-transitory computer readable storage medium, wherein the non-transitory computer readable storage medium stores a computer program executable for a computing device, and the computing device is enabled to execute steps of the method according to claim 1 when the program runs on the computing device.
